(19) United States
(12) Patent Application Publication
(10) Pub. No.: US 2002/0120702 A1
(43) Pub. Date: Aug. 29, 2002

(54) Method and apparatus for dynamic prioritization of electronic mail messages

(76) Inventors: Vincent J. Schiavone, Berwyn, PA (US); James H. Koenig, Philadelphia, PA (US)

Correspondence Address: Gregory S. Bernabeo, Esquire, Synnestvedt & Lechner, LLP, 2600 Aramark Tower, 1101 Market Street, Philadelphia, PA, 19107-2950, US

(21) Appl. No.: 09/792,936

(22) Filed: Feb. 26, 2001

(51) Int. Cl. G06F 15/16

(52) U.S. Cl. 709/207

(57) ABSTRACT

A method for prioritization of a recipient's electronic mail messages. Messages are displayed in descending order of an associated priority bid. Messages include an initial priority bid and/or a maximum priority bid, e.g., a cash value. An incoming message's initial bid is compared to current bids of previous messages and the bid is increased if it is lower than any previous message's current bid so that it will appear first in descending sorted order, e.g. in the recipient's electronic mail inbox, and thus have priority. Prioritization may continue to permit a previous message to increase its bid until it has the highest priority bid among the messages or until the incoming message has a priority bid higher than the maximum bid of all previous messages or until the incoming mail message reaches its maximum bid. Messages may be displayed in categorized sections and prioritization performed on fewer than all sections.

### FIELD OF THE INVENTION

This invention relates generally to the fields of auctions and electronic mail and particularly to a method and apparatus for dynamic prioritization of electronic mail messages including by automated bidding for a priority listing of a message in an recipient's mail inbox.

### BACKGROUND OF THE INVENTION

Communications networks, such as the Internet, are now being widely used internationally for the transmission of electronic mail (“e-mail”) messages. While Internet e-mail has long been used for personal matters, it is now being heavily used for marketing purposes. The reach of marketing e-mail by legitimate and illegitimate marketers is often overly broad because e-mail is quickly, easily and inexpensively sent. As a result, many individual e-mail users receive unwanted and/or unsolicited bulk e-mail typically referred to as “spam”. While a small amount of spam may be a minor annoyance to a user, a large amount of spam can be overwhelming, time-consuming to deal with, and extremely aggravating to the user. Additionally, the presence of many unwanted or unimportant messages distracts the user from the relatively few important ones, effectively generally reducing recipient responsiveness thereto and thus diluting electronic mail's value as a communications medium.

E-mail messaging is also widely used for business-related or organization-related (collectively, “corporate”) communications. In many corporations, for example, nearly all employees are provided with an electronic “mailbox” for receiving corporate e-mail messages. The problems of spam e-mail is compounded for the many recipients that have multiple e-mail addresses, e.g., one or more personal addresses for receiving personal e-mail and at least one corporate e-mail address for receiving corporate e-mail. Such recipients typically receive both important and unimportant e-mail messages at each e-mail address, further complicating the process of finding important messages among the unimportant ones and further diluting electronic mail's value. As a result, the efficacy of e-mail is lessened because some important messages are overlooked until after a critical date.

A simplified, general, explanation of an electronic mailbox, an inbox, and the operation of a typical e-mail system is provided in U.S. application Ser. No. ______ (Attorney Docket No. P24618 USA), filed ______ now U.S. Pat. No. ______, the disclosure of which is incorporated herein by reference.

Various approaches have been taken to preserve the integrity and efficacy of the electronic mail medium and responsiveness of recipients thereof. For example, filtering approaches reduce the amount of e-mail received by a recipient, i.e. displayed in the inbox of a recipient's mail reader software, by eliminating certain messages before they are displayed. For example, e-mail may be filtered by content, sender, or other criteria such that mail intended for delivery to a recipient is not received unless it meets filtering criteria. Another filtering approach is permission-based marketing, in which commercial e-mail is sent only to those users who have previously consented to receive such e-mail.

U.S. Pat. No. 5,999,967 to Sundsted, the disclosure of which is incorporated herein by reference, generally discloses filtering electronic mail on the basis of a value of an electronic “stamp” attached to an e-mail message. The value of the stamp is payable to the recipient. The recipient can reject e-mail messages having a stamp valued at less than the recipient's desired amount of compensation. See, e.g., Sundsted, col. 6, lines 28-33, col. 6, line 65-col. 7, lines 1-40, col. 8, lines 25-30.

Filtering approaches overly narrow the class of recipients because, for example, they eliminate recipients that have not expressly granted their consent yet would be agreeable to receiving commercial e-mail and/or those recipients that have poorly defined filtering criteria. This is particularly a problem for new services or products that may interest the recipient but of which the recipient is unaware, or in connection with new customer acquisition strategies generally (e.g. Charles Schwab's e-mailing of existing Fidelity customers in an effort to acquire new customers and gain market share; Citibank to MBNA customers; and Amazon.com to Barnes & Noble customers).

An alternative to the filtering approach is the prioritizing approach, i.e., identifying certain messages as having a higher priority than others. Filtering may affect the which messages appear in the inbox or the way in which they are displayed in the inbox. An image of an exemplary inbox window 12 of a mail reader display 10 of the prior art is shown in FIG. 1. The mail reader display 10 is displayed on a video monitor of a recipient's general purpose computer by a mail reader software program stored and running on the computer. Outlook® and Outlook Express® are examples of mail reader software programs distributed by Microsoft Corporation of Redmond, Wash., U.S.A. Such mail reader software programs are used to receive, manage and display e-mail messages received in an electronic mailbox. Other mail reader software and/or communications devices for receiving electronic mail messages are well known in the art, including wireless telephones, wireless personal digital assistants such as a Palm VII® device, an instant messaging device (such as that capable of receiving ICQ (icq.com) and/or AOL.com's Instant Messenger® messages) and/or a pager. Typically, mail reader software programs may be configured to display electronic mail messages received in one or more electronic mailboxes having one or more electronic addresses. All messages appear in the inbox window 12. The inbox window typically displays header information of each e-mail message in a list format. Upon a recipient's selection of a message in the list, the contents of the message, e.g., text, is displayed. In the example of FIG. 1, the inbox window 12 includes a single section 14 at least three columns, a “From” column 16 for displaying header information identifying an identity or address of a sender of a message, a “Subject” column 18 for displaying a header information identifying a subject of a message, and a “Received” column 19 for displaying information identifying a time of receipt of a message.

Most mail reader software includes functionality for marking a certain message as having a higher priority than others. The priority marking can be toggled on and off and is not hierarchical in nature. Urgent messages are typically shown “flagged” in a recipient's electronic “inbox” with boldface text, and/or an with an icon, such as an exclamation point. However, a later received, non-urgent item, will typically be listed in an inbox above the urgent item. This may continue until the urgent item no longer appears in a viewable portion of the inbox. This effectively defeats the urgent flag.

Another prioritizing approach involves sorting. U.S. Pat. No. 5,694,616 to Johnson et al., the disclosure of which is incorporated herein by reference, discloses prioritization of e-mail messages having a priority attribute. A recipient's inbox is sorted such that all e-mail messages received with a priority attribute are listed before all e-mail messages received without an assigned priority attribute. Messages within the priority or non-priority section of the inbox may be sorted using other criteria. See, e.g., Johnson, col. 4, lines 18-33, col. 5, lines 1-5.

U.S. Pat. No. 5,948,058 to Kudoh et al., the disclosure of which is incorporated herein by reference, discloses an electronic mail cataloging and retrieving system for indicating a classification for each message in an inbox. Message header information, such as subject, sender identity or address, etc. of all received messages is shown in the inbox of mail reader software by a header information display control unit. Messages are classified by displaying a mark in a column of a tray display shown adjacent the inbox. Each column represents a unique classification category and a mark in a column indicates that the associated message belongs to the classification represented by that particular column. See, e.g., Kudoh, FIGS. 3, 6, 10, and 12.

U.S. Pat. No. 5,999,967 to Sundsted discloses assigning a priority to an incoming e-mail message as a function of the value of its stamp and presenting the e-mail messages to the recipient in a sorted order of priority. See Sundsted, col. 11, lines 1-6.

These known methods fail to afford flexibility to the sender to ensure priority of the sender's e-mail message while preventing undue cost to the sender. Additionally, these methods are limited because the value associated with an email is uniformly specified by the sender for all recipients, which may be too low for some recipients and higher than necessary for others. Finally, these methods are insufficient because they ignore differences between mail messages and treat all mail similarly, e.g. a commercial message from an unknown sender with a stamp value of five cents would always have priority over a personal message, e.g, from a spouse, to which value is not attached. In most instances, this leads to undesirable effects.

### SUMMARY OF THE INVENTION

Generally, the present invention provides a method and apparatus for dynamic prioritization of electronic mail messages. Messages are prioritized, and/or reprioritized, each time a new message is received. In accordance with the present invention, a user's electronic mail messages are displayed in a sorted order, preferably in descending order of priority bids associated with each of the messages. Each priority “bid” is an amount payable to and/or receivable by the recipient of the message, e.g, in U.S. currency or other units of value, such as airline frequent flyer miles, etc. Alternatively the “bid” may be an amount paid or payable to an advertising agency or other intermediary by a marketer for delivery of the message.

Payment of the priority bid may be contingent on a certain act, such as delivery or opening of the message, or a response thereto, including a click-through to a website, registration with a website, or referral of others to a website (e.g. a viral, pass-along message which is part of a viral marketing campaign), and/or enrollment/purchase as a customer of the sender. In this manner, messages having a higher priority bid appear first and are effectively given priority because they are more likely to be viewed, or viewed first, by a user.

Messages include an initial priority bid, e.g., a cash value. When an incoming message is received, its initial priority bid is compared to priority bids of previously received messages. If the incoming message's priority bid is higher than all other messages' priority bids, it will appear first in descending sorted order and thus have priority. If the incoming message's priority bid is lower than any previously received message's priority bid, the incoming message's priority bid is increased so that it will appear first in descending sorted order and thus have priority. This effectively creates a “reverse auction” for priority, with individual messages effectively bidding for a priority listing in a recipient's inbox. In the preferred embodiment, each message includes a maximum bid that limits the extent to which an incoming message's priority bid may be increased. Accordingly, messages are modified after the receipt by the recipient, based on a current state of messages and current priority bids of messages in the mailbox. The customer tailors each bid to each recipient for any given point in time.

In one embodiment, the reverse auction continues after an incoming message obtains priority through its bidding. The continued reverse auction permits a previously received message to increase its priority bid until it will appear first in descending sorted order, the incoming bid to again increase its bid, and so on. The reverse auction further continues until the incoming mail message has a priority bid higher than the maximum bid of all previously received messages, until the incoming mail message reaches its maximum bid, at which point the incoming message may not appear first in descending sorted order, or until the user reads or otherwise takes action in connection with received mail, including opening and/or reading the message, a click-through to a website, registration with or referral of others to a website (e.g., a viral, pass-along message which is part of a viral marketing campaign), and/or enrollment/purchase as a customer of the sender.

Optionally, the reverse auction may continue only for messages in an auction pool and messages may remain in the auction pool for a limited period. In such an embodiment, after the auction period expires, messages in the auction pool are removed and the reverse auction ends as to those messages. New messages are placed in the auction pool and appear in a sorted inbox separately from the messages removed from the auction pool, e.g., all auction pool messages being listed before all any messages removed from the auction pool.

Additionally, the present invention provides a method and apparatus for providing a categorized display of a recipient's electronic mail messages and/or creates and routes the messages to different folders or sections of a categorized inbox. More specifically, each received message is associated with a category of a recipient's categorized inbox. The categorized inbox is sectioned to provide for display of each message's header information in a section corresponding to the category associated with the message. The header information of a message is then displayed to the recipient in a section of the inbox that corresponds to the category associated with the message. In this manner, incoming mail is sorted by category and displayed to the recipient in a comprehensive, easily browsable format. Advantageously, messages may be prioritized separately, as described above, in each individual section of the categorized display. In this manner, for example, a commercial message with a high priority bid may get first priority in a commercial section of the categorized display while a spouse's message, without any priority bid, may get first priority (e.g., based on sender identity) in a personal section of the categorized display.

Broadly, the inventive method includes the steps of receiving an electronic mail message, associating the electronic mail message with a category, and causing information identifying said electronic mail message to be displayed in a corresponding section of a plurality of sections of a mail reader display, the corresponding section corresponding to the category.

Apparatuses and computer program products for carrying out the present invention are provided.

### DESCRIPTION OF THE DRAWINGS

FIG. 1 is an image of an exemplary mail reader display of the prior art;

FIG. 2 is a flow diagram of an exemplary dynamic prioritization transaction in accordance with one embodiment of the present invention;

FIG. 3 is a flow diagram of an exemplary message priority bidding process of FIG. 2; and

FIG. 4 is an image of an exemplary mail reader display in accordance with one embodiment of the present invention;.

FIG. 5 is a flow diagram of an exemplary electronic mail categorization transaction in accordance with one embodiment of the present invention;

FIG. 6 is a flow diagram of an exemplary association process of FIG. 5;

FIG. 7 is an image of an exemplary categorized mail reader display in accordance with the present invention; and

FIG. 8 is a block diagram of an exemplary electronic mail computer in accordance with the present invention.

### DETAILED DESCRIPTION

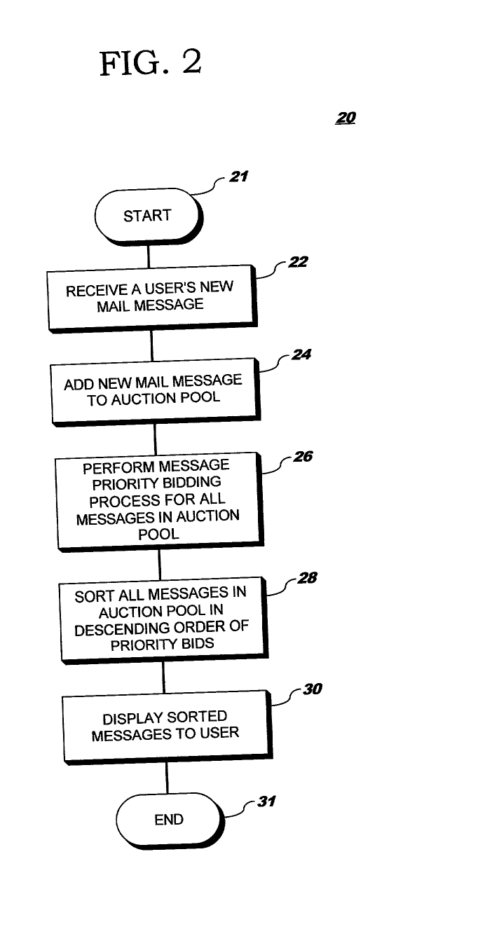

The present invention provides a method and apparatus for dynamic prioritization of electronic mail messages. FIG. 2 is a flow diagram 20 of an exemplary dynamic prioritization transaction in accordance with one embodiment of the present invention. The exemplary transaction of FIG. 2 starts with receipt of a user's new electronic mail message, i.e., an incoming message, as shown at steps 21 and 22. In one embodiment, the incoming message is received into an incoming message queue of a mail server computer in a known manner, where it is stored for later retrieval by a user using a mail client computer running mail client software. In the example of FIG. 2, the incoming mail message is received and stored at the mail client computer. Computer hardware and software for receiving and storing electronic mail messages are well known in the art.

In one embodiment, the auction pool does not include the incoming message and the dynamic prioritization process is performed for all messages in an auction pool and the incoming message. In the example of FIG. 2, the auction pool includes the incoming message and is the complete collection of messages for which the dynamic prioritization process will be performed. Accordingly, the new mail message is next added to an auction pool, as shown at step 24. Preferably each auction pool includes only a subset of all messages received, e.g., messages received during a one week period, and auction pools have continuous, consecutive auction periods. In this example, an auction pool is maintained which includes all messages received during a one week period, at which point such messages are removed from the auction pool, and new messages received during the next one week period are added to the auction pool. Programming techniques for implementing this functionality are well known in the art.

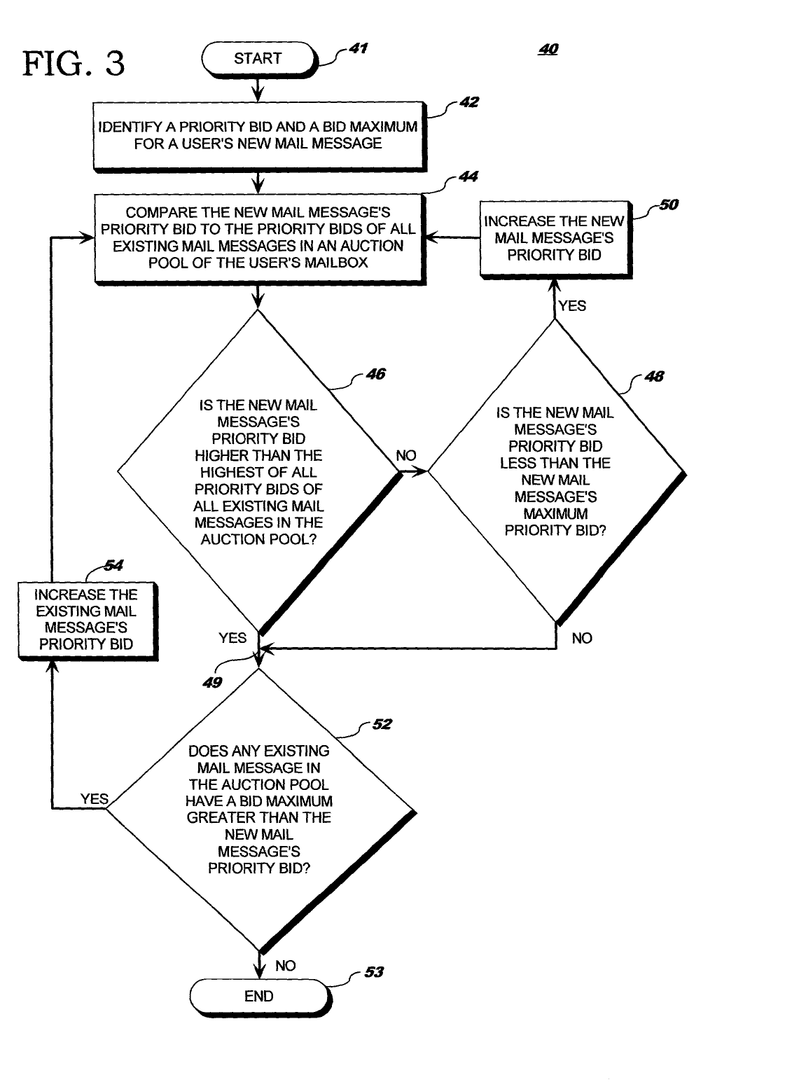

Next, a message priority bidding process is performed for all messages in the auction pool, as shown at step 26 in FIG. 2 and as discussed in detail below with respect to FIG. 3. During this step, the heart of the dynamic prioritization, a reverse auction process, occurs. In this step, a priority bid associated with an incoming message, and/or priority bids associated with existing, previously-received messages in the auction pool are incrementally increased, each message effectively “bidding” for priority, e.g, to be listed first, in a display of an electronic mailbox (inbox) that is sorted in descending order of priority bid values. The priority bidding process continues until the incoming mail message has a priority bid higher than the maximum bid of all previously received messages or until the incoming mail message reaches its maximum bid, at which point the incoming message may not appear first in the sorted inbox.

FIG. 3 is a flow diagram 40 of the exemplary message priority bidding process shown at step 26 of FIG. 2. The process of FIG. 3 is carried out by software according to the present invention. Programming methods for writing software code for carrying out the processes described in the flowcharts herein are well known in the art. In the example of FIG. 2, each message includes an initial priority bid, e.g. a minimum bid, and a maximum bid established by a sender of the message and stored in header information of the message. Although the bid could be offered in a variety of different units, e.g., airline frequent flyer miles, free minutes of Internet connection time, in this example, the bid is expressed in terms of an amount of U.S. currency. Although the bid could reflect an amount receivable by a recipient of the message from an entity other than the sender of the message, in the example of FIG. 2, the bid reflects an amount payable to the recipient by the sender. Sending an electronic mail message including a minimum priority bid and/or a maximum priority bid requires modifications to existing mail software or software according to the present invention to include such bids, or bid data, in a mail message. Programming methods for creating and/or modifying software to perform such functions are well known in the art. An exemplary novel method for performing such functions is disclosed in U.S. application Ser. No. ______ (Attorney Docket No. P24528 USA) titled System and Method for Rule-based Processing of Electronic Mail Messages, filed ______, now U.S. Pat. No. ______, issued ______, the disclosure of which is incorporated herein by reference.

As shown in the example illustrated in FIG. 3, in accordance with the present invention, the priority bidding process starts with identification of a priority bid and a maximum bid of a user's new (incoming) mail message, as shown at steps 41, 42. In this example, the inventive software program is configured to identify and extract such information from the message itself. In an alternate embodiment, the priority bid and/or the maximum bid is extracted from a separate “bid message” associated with the incoming mail message. In yet another alternate embodiment, such bid information is extracted from a database storing sender-specific bid data. Such bid information may be identified in any other suitable manner.

Next, the new message's priority bid is compared to the priority bids of all other previously received, i.e., “existing”, messages in the auction pool of a recipient's inbox, as shown at step 44. It is then determined whether the new message's priority bid is higher than the highest of all priority bids of all existing messages in the auction pool, as shown at step 46. In this example, steps 44 and 46 are achieved by comparing the new message's priority bid to the respective priority bids of every other message in the auction pool. In an alternate embodiment, steps 44 and 46 are effectively performed by comparing the new message's priority bid only to the first listed (highest) priority bid in an auction pool in which the existing messages are already sorted in descending order of priority bids. Steps 44 and 46 may be accomplished in any other suitable way.

If the new message's priority bid is not higher than the highest of all priority bids of all existing messages in the auction pool, it is next determined whether the new message's priority bid is less than its maximum bid, as shown at step 48. For example, this may be achieved by comparing the new message's current priority bid to its maximum bid. The new message's priority bid is then increased, as shown at step 50, preferably to an amount not exceeding the maximum bid. For example, the size of the increment by which the bid is increased can be determined by the user, the sender of the message (for example, by including the increment information in the message), by an outside party, by mathematical techniques, by increasing to the message's maximum bid, by increasing to match the maximum bid of another message. The new mail message's increased priority bid is then compared to the priority bids of other messages in the auction pool and the process continues, as shown at steps 44 and 46.

If the new mail message's priority bid is not less than its maximum bid in step 48, then the process continues as shown at point 49 in FIG. 3. Alternatively, if the new message's priority bid is higher than all priority bids of all existing mail messages, then the process continues as shown at point 49 in FIG. 3. At this point, the new message has a highest priority bid and therefore will have priority when the messages, or a list of such messages, are shown in descending sorted order of priority bids in a recipient's inbox. It should be noted that the priority bid may reflect an amount paid (or payable) to the recipient to get the message placed in the recipient's inbox. For example, the priority bid may be set after reference to a recipient-specified minimum bid amount stored in a recipient's profile data, as generally disclosed in U.S. application Ser. No. ______, titled System and Method for Rule-based Processing of Electronic Mail Messages (Attorney Docket No. P24528 USA), filed ______, now U.S. Pat. No. ______, issued ______. Alternatively, the priority bid may reflect an amount or amounts payable to the recipient for various actions, e.g., delivery of the message, opening and/or reading the message, clicking on a link embedded in the e-mail to visit a certain website, registration at that website by submitting information into a Web-based (or e-mail-based) form (e.g. to subscribe or become a member), etc. Programming methods for writing software code for carrying out the such processes are well known in the art. One particular method is disclosed in U.S. application Ser. No. ______ titled System and Method for Rule-based Processing of Electronic Mail Messages, filed ______ (Attorney Docket No. P24528 USA), now U.S. Pat. No. ______, issued ______.

In some embodiments of the present invention, the process ends at point 49 in FIG. 3. However, in this example, the priority bidding process continues to permit existing messages to bid again for priority, e.g., to be listed first, in the recipient's inbox. Accordingly, it is next determined whether any existing mail message in the auction pool (other than the new message) has a maximum bid greater than the new message's priority bid, as shown at step 52. A message in the auction pool having a priority bid less than or equal to the priority bid of the incoming message is referred to herein as an “underbid” message. Implicitly, step 52 involves identifying a maximum bid for an underbid message.

If there is no underbid message having a maximum bid greater than the new message's priority bid, then the new message will be listed first in the sorted inbox and the process ends, as shown at step 53. However, if such an underbid message is found in step 52 and the underbid message has a maximum bid greater than its priority bid, the underbid message's priority bid is increased, as shown at step 54, preferably to an amount less than the underbid message's maximum bid.

The priority bidding process then continues with comparing of the new message's priority bid to the existing message's increased priority bid, as shown at step 44. The entire priority bidding process continues until the new (incoming) message has a priority bid higher than the maximum bid of all existing (previously received) messages or until the new message reaches its maximum bid, at which point the incoming message may not appear first in descending sorted order.

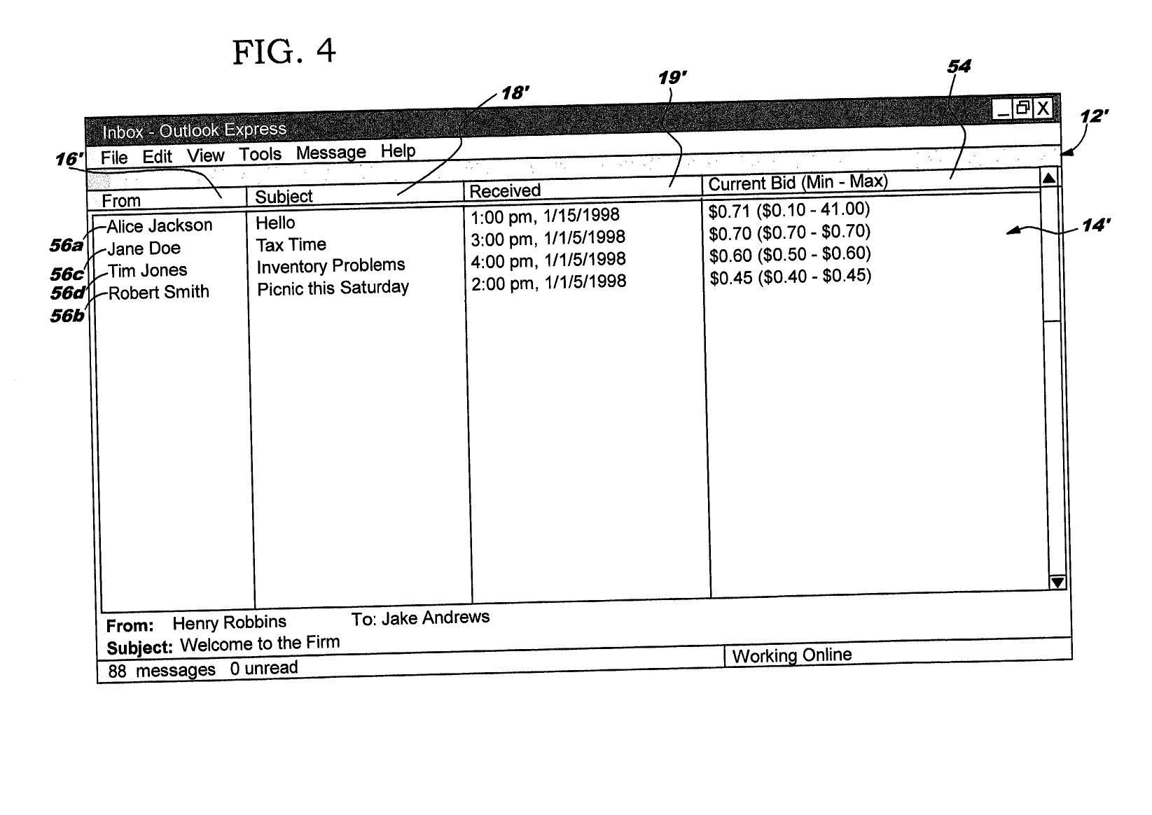

Referring now to FIG. 2, once the priority bidding process of FIG. 3 is complete, as shown at step 26 in FIG. 2, all messages in the auction pool are sorted in descending order of priority bids, as shown at step 28. The messages are then displayed to the user in sorted order, as shown at step 30 and the transaction ends, as shown at step 31. More particularly, a list of messages is shown in the recipient's inbox window 12′, as shown in FIG. 4. Typical mail reader software programs provide an inbox window that displays a list of mail messages, where each list entry includes a display of message header information, etc. Preferably, the list also displays the current priority bid for each message, as in the priority bid column 54 of FIG. 4. This indicates the message's worth to the user and the user will likely give priority to messages of greater worth. For example, a message the recipient will be paid $2 for reading will likely be read by the recipient before a message for which the recipient will be paid $1. Accordingly, messages with the highest priority bids are listed first in a recipient's inbox window 12′.

Referring now to FIG. 4, an inbox window 12′ having a single section 14′ is shown. The inbox window 12′ includes columns for displaying the sender's identify or address (column 16′), the subject of the message (column 18′), a received date stamp (column 19′) and a priority bid column 54. Four messages 56a, 56b, 56c, 56d are shown in FIG. 4, after the reverse auction bidding process has been completed. Initially, a message from Alice Jackson (message 56a) is received at 1:00 pm with a current priority bid of $0.10 (equal to the minimum set by the sender). This establishes message 56a as the first listed (thus, highest priority) message in the inbox window 12′. In this embodiment, the minimum priority bid may be adjusted as a function of data stored in the recipient data store, such as a minimum acceptable priority bid. Messages having a minimum priority bid which is below the minimum acceptable priority bid may have their current priority bid increased to meet the minimum acceptable priority bid, at which time the message is delivered to the recipient and/or displayed in the inbox window. Messages having a maximum priority bid which is below the minimum acceptable bid may optionally be rejected.

Next, message 56b is received at 2:00 pm from Robert Smith with a current priority bid of $0.40 (equal to the minimum set by the sender) which establishes message 56b as the first listed message. However, the automated reverse auction bidding process then takes place, preferably before display of message 56b in the inbox window 12′, causing message 56a to outbid message 56b until message 56b's maximum bid ($0.45) is met, at which time message 56b has a current bid of $0.45, message 56a has a higher bid, e.g. $0.46, and message 56a is listed first and message 56b is listed second. Message 56b cannot raise its priority bid because it has reached its maximum bid value ($0.45).

Next, a third message 56c is received from Jane Doe at 3:00 pm, having a minimum priority bid of $0.70. This would entitle message 56c to first listed priority. However, the automated reverse auction bidding process then takes place, causing message 56c to reach its limit ($0.70) and message 56b to outbid message 56c, e.g. with a bid of $0.71. At this point, message 56a is still listed first, message 56c is listed second and message 56b is listed third.

Finally, in this example, message 56d is received from Tim Jones at 4:00 pm. In this example, message 56d's minimum bid is sufficient to outbid message 56b and its maximum bid is insufficient to outbid message 56c. In some embodiments, message 56d would retain its minimum bid ($0.50) because raising its current bid will not result in a change in order of priority. In this embodiment, the bidding is incremental, and message 56d keeps increasing its current priority bid during the automated reverse auction bidding process in an attempt to outbid message 56d, resulting in a current priority bid equal to its maximum priority bid ($0.60). Accordingly, message 56d establishes itself as the third-listed message, as shown in FIG. 4.

This bidding process continues with each new message entering the auction pool until the auction pool is closed, e.g., by expiration of a time period, user-defined number of acceptable unsolicited commercial e-mail messages, etc. Messages are removed from the auction pool, and bidding for that message ceases, after performance of a prescribed action, e.g., opening of the message or downloading of messages.

In this manner, a sender of an electronic mail message may send a message which includes sufficient flexibility to help ensure priority of the sender's message (by being listed first, or close to first, and by having a relatively high priority bid) without undue cost to the sender due to endless bidding. Also, messages may be sent and priority maintained without the need to send a message with an unduly large priority bid. Each message's bid is increased from a minimum only enough to maintain a priority listing, and no more.

The present invention also provides for categorization and categorized display of messages in a recipient's inbox. This effectively divides the recipient's inbox into sections acting as multiple inboxes, each section displaying messages falling in a certain corresponding category. The messages appearing in the various sections may be addressed to one or more of the recipient's e-mail addresses. This enhances the efficacy of the e-mail messaging and counteracts dilution caused by the receipt of numerous, unimportant e-mail messages by segregating mail into meaningful categories. For example, unwanted spam may be displayed in a “bulk” mail category, while commercial e-mail messages may be displayed in a “business” mail category and personal e-mail messages may be displayed in a “personal” mail category. Optionally, mail having maximum priority bids less than a minimum acceptable priority bid established by the recipient may be categorized as bulk mail and listed in the bulk mail section of the categorized display.

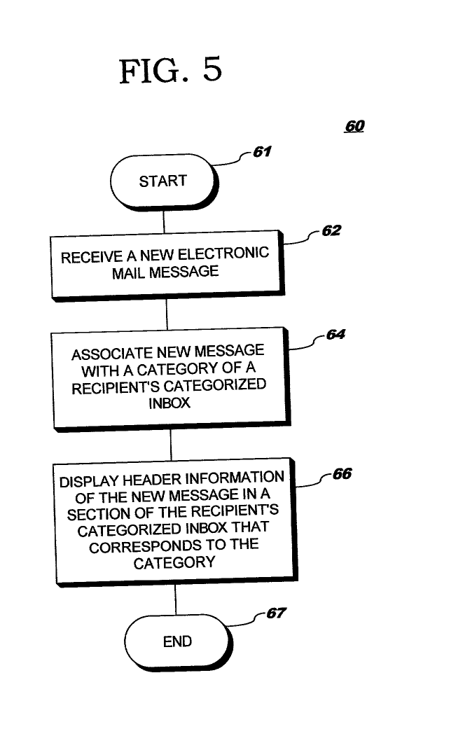

FIG. 5 is a flow diagram 60 of an exemplary electronic mail categorization transaction in accordance with one embodiment of the present invention. The categorization transaction begins with receipt of a new e-mail message, as shown at steps 61 and 62 in FIG. 5. In an embodiment in which step (a) is performed at a mail server computer, e.g., a general purpose computer running mail server software, step 62 involves receiving the e-mail message in an incoming message queue of the mail server computer. In an alternate embodiment in which step (a) is performed at a mail client computer, e.g., a general purpose computer running mail client software, step 62 involves receiving the e-mail message at the mail client computer. Mail server software and mail client software for receiving messages are well known in the art.

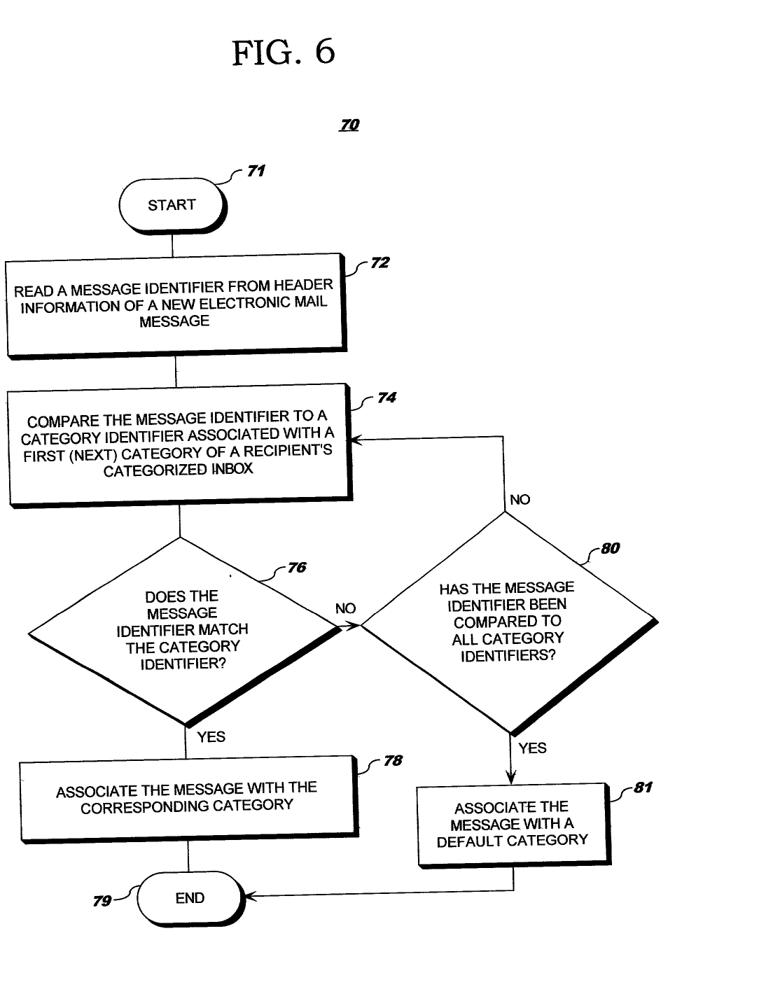

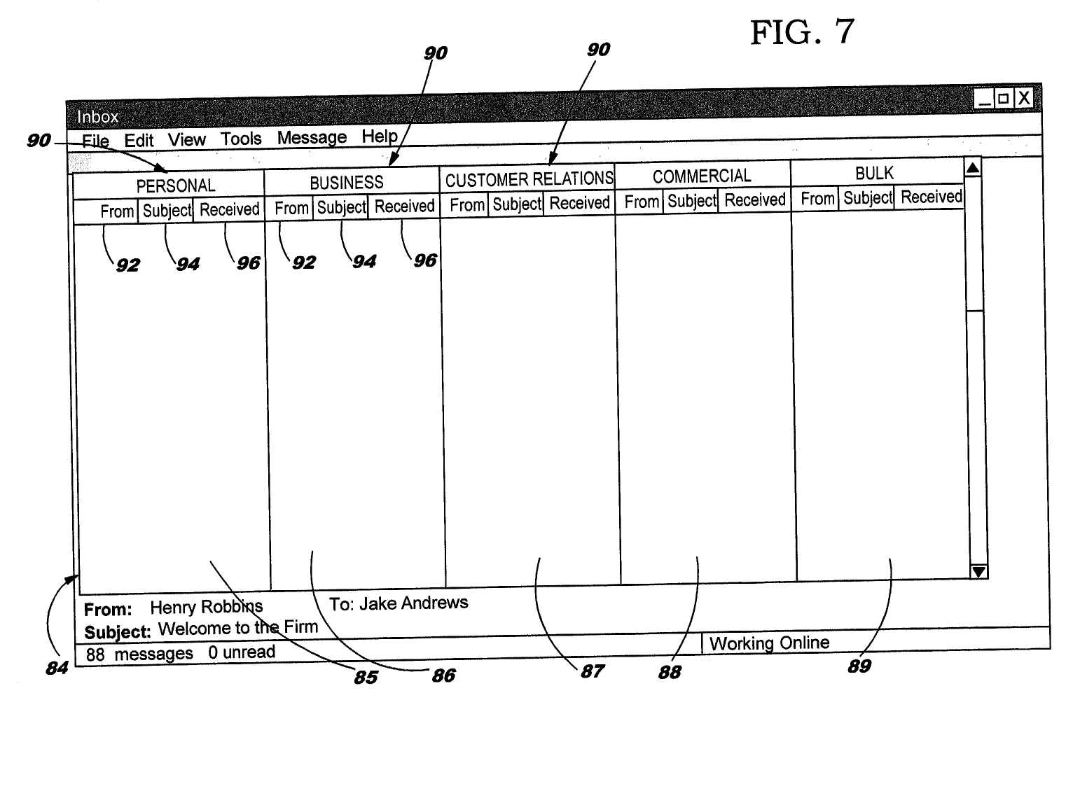

Next, the new e-mail message is associated with a category of a recipient's categorized inbox, as shown at step 64. This step may be performed at a mail client computer or a mail server computer. As used herein, a “computer” may be a PC, personal digital assistant, a web- or text-enabled wireless telephone, wireless personal digital assistant such as a Palm VII® device, an instant message-enabled device, a pager or any other like device. An exemplary categorized inbox 84 in accordance with the present invention is shown in FIG. 7 and discussed in detail below. In accordance with the present invention, the association process may be accomplished in a variety of ways. FIG. 6 is a flow diagram 70 of an exemplary association process of step 64 shown in FIG. 5.

As shown in FIG. 6, the exemplary association process begins with reading of a message identifier from header information of the new e-mail message, as shown at steps 71 and 72. In such an embodiment, the message identifier is included in the message, e.g., in an identifier field included in the message in accordance with the present invention, by inventive software used by the sender or another party such as an Internet service provider.

In an alternate embodiment, a message identifier associated with the message is identified by reading the message identifier from a database of message identifiers stored in a memory, e.g., a memory at the mail client computer. For example, categorization software in accordance with the present invention may identify a sender of the message and reference a database to determine a message identifier associated with the sender. Other methods for identifying a message identifier associated with the message will be obvious to those of skill in the art and any suitable method may be used.

In the example of FIG. 6, the message identifier identified in step 72 is then compared to a category identifier associated with a first or next category of a recipient's categorized inbox, as shown at step 74. For example, this step may involve identifying a corresponding category of a mail reader display, e.g., by referencing a database of message identifiers and corresponding categories. Specifically, this may be achieved by comparing a message identifier from the new message to a plurality of category identifiers, as discussed further below.

FIG. 7 is an image of an exemplary categorized mail reader display 82 in accordance with the present invention. The mail reader display 82 is displayed on a video monitor, e.g., a CRT of a personal computer, an LCD or other screen of a laptop computer, personal digital assistant, web-enabled cellular phone, etc. Mail reader display 82 has a categorized inbox window 84 including multiple sections 85, 86, 87, 88, 89. Each of the multiple sections is displayed in a subwindow of the inbox window 84. Each of the multiple sections is associated with a separate category of the recipient's inbox. For example, the Personal category is displayed in the Personal section (i.e., subwindow) 85 of the categorized inbox window 84. In this example, the category identifier for the Personal category may be the word “personal”. In this example, each of the sections forms a separate column 90 of the categorized inbox window 84. In one embodiment, each section corresponds exclusively to a single category for displaying information relating to message falling in the single category. In this example, each of the multiple sections 85, 86, 87, 88, 89 has at least three columns, a “From” column 92 for displaying header information identifying an identity or address of a sender of a message, a “Subject” column 94 for displaying a header information identifying a subject of a message, and a “Received” column 96 for displaying information identifying a time of receipt of a message. Preferably, at least a portion of each section is concurrently displayed on a video monitor so a recipient can view message information in multiple categories in a single field of view. Each section could also include columns (not shown), etc. for displaying additional information, such as an icon indicating that the message is read or unread, that a file is attached, or that the message is marked as “urgent”, etc. In other words, each section, i.e., each subwindow, e.g., column, is arranged to display information of the type displayed by an inbox window of a traditional mail reader display.

In the example shown in FIG. 6 it is next determined whether the message identifier matches the category identifier, as shown at step 76. For example, consider a message having a message identifier of “commercial” and category identifiers of “personal”, “business”, “customer relations”, “commercial” corresponding to the categories of “personal”, “business”, “customer relations”, and “commercial”. In this example, there is a “bulk” default category, as discussed below. The particular names of the categories is not as important as the standardized or common use of category nomenclature or logic.

If in step 76, the message identifier does not match the category identifier identified in step 74, it is next determined whether the message identifier has been compared to all category identifiers, as shown at step 80. If not, steps 74 and 76 repeat, as shown in FIG. 6. In this example, the commercial message identifier would not match the personal category identifier, in step 76 and the message identifier has not been compared to all category identifiers, so the process repeats. This continues until the “commercial” message identifier is compared to the “commercial” category identifier, at which point a match is found in step 76.

When a match is found in step 76, the message is associated with the corresponding category, as shown at step 78 and the process of FIG. 6 ends, as shown at step 79. In this example, the message is associated with the commercial category.

If the message identifier had not been “commercial” and had not matched any other category identifier, or if the message contained no message identifier, then there would be no match found in step 76 although the message identifier (or no message identifier) had been compared to all category identifiers in step 80, accordingly, the message is associated with a default category, e.g., “bulk”, in step 81 and the process of FIG. 6 ends, as shown at step 79.

Finally, as shown at step 66 in FIG. 5, information relating to the message, e.g., header information, is displayed in a section of the recipient's inbox that corresponds to the category associated with the message in step 64. In the example, discussed above, the message having the “commercial” message identifier is displayed in section 88 of the categorized inbox of the mail reader display in step 66. The transaction then ends, as shown at step 67 in FIG. 5.

For further illustration, consider that in addition to receiving a first electronic mail message having a “commercial” message identifier, a second electronic mail message having a “personal” message identifier is received. In accordance with the present invention, information relating to the first e-mail message, e.g., header information, is caused to be displayed in the commercial category section 88 of the categorized inbox 84 and information relating to the second e-mail message is caused to be displayed in the personal category section 86 of the categorized inbox 84. For example, a mail client computer may cause its video monitor to display such information by sending a signal locally in a traditional manner, a mail server computer may cause such information to be displayed by sending an appropriate signal to the mail client computer for subsequent processing and/or signaling to cause the mail client computer to display such information.

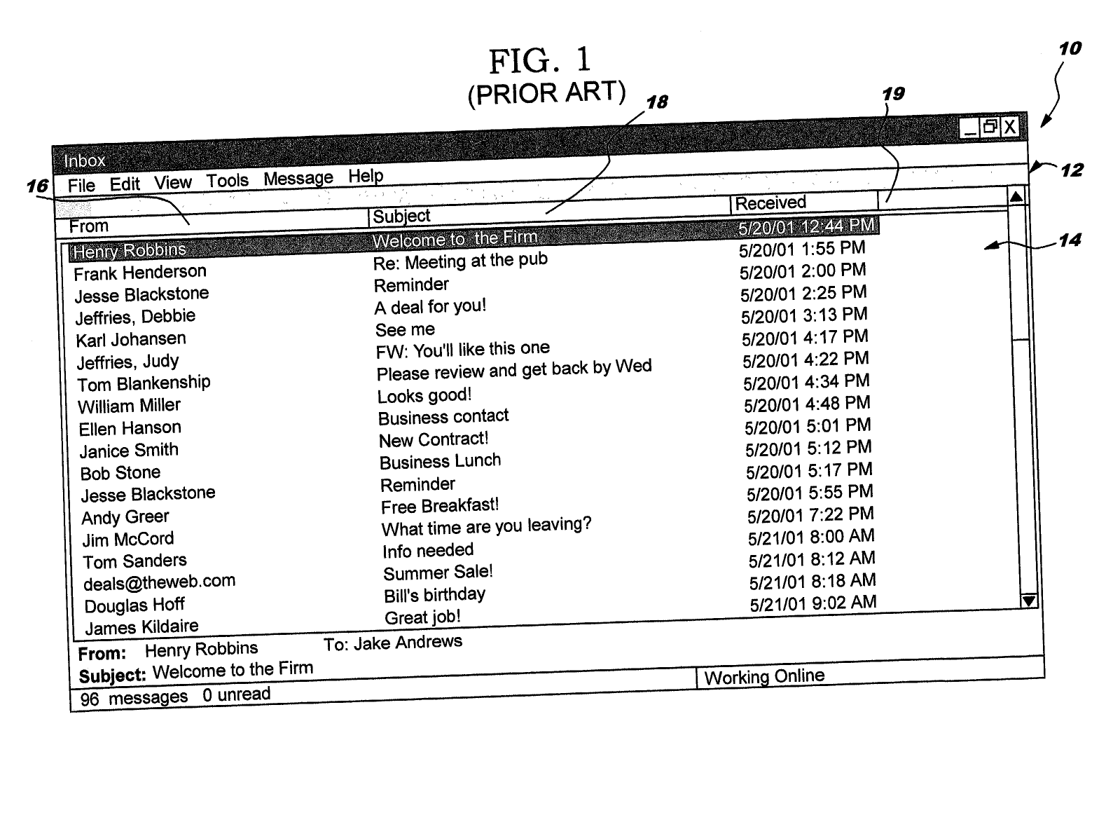

In this manner, each section 85, 86, 87, 88, 89 of the categorized inbox 84 now functions as separate inbox. Accordingly, various prioritization, filtering, and/or sorting techniques and can used within each category. In particular, it is advantageous to use in a single section of the categorized inbox, e.g., the commercial or bulk category section, the dynamic prioritization, i.e., reverse auction, process described above in reference to FIGS. 1-4. Other sections may be prioritized by a separate reverse auction, known prioritization techniques (date/sender/priority flag sorting), or not at all.

The invention also provides a method for sending categorizable electronic mail messages in an electronic mail system. The method includes the step of preparing an electronic mail message for transmission to a recipient. This may be accomplished in a manner generally known in the art. The method also includes the step of including in the electronic mail message category identification data usable to associate the electronic mail message with a corresponding section of a plurality of sections of a recipient's mail reader display. This step is performed using software in accordance with the present invention. Finally, the electronic mail message is transmitted via an electronic mail system using transmission methods well known in the art.

It is noted that in some embodiments, an incoming message's priority bid is compared to a recipient's minimum acceptable priority bid. In such an embodiment, the recipient can control the amount of message the recipient receives, or adjust the recipient's tolerance for such e-mail messages, by altering the minimum acceptable priority bid. For example, by setting the bid value very high, most messages will be excluded because their maximum priority bids will be less than the minimum acceptable priority bid. In this way, the invention effectively filters out certain messages with low bid values. Alternatively, the recipient can invite many mail messages generally, or with respect to a particular ares (by category, keyword, subject matter, sender or otherwise) by setting the recipient's minimum acceptable bid value for such area to a relatively small amount. For example, a child may wish to set the minimum acceptable priority bid very high to block all or almost all commercial email, which is likely to offer priority bids. By way of further example, an individual looking to purchase a car may selectively lower the individual's minimum threshold related to cars/car accessories and/or insurance as a way to solicit bids and offers to consider.

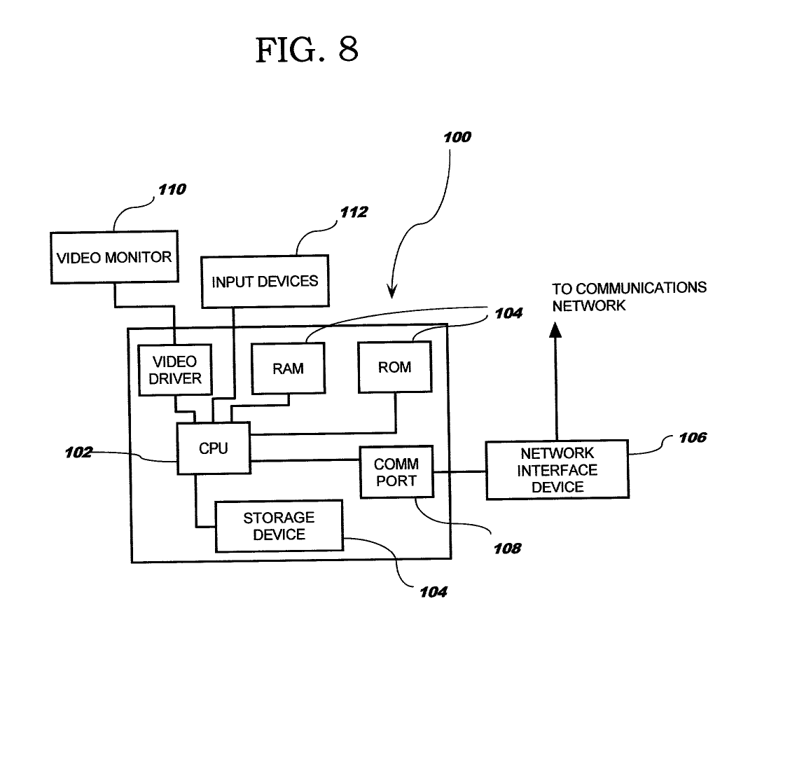

The method of the present invention may be implemented through the use of one or more computers having typical hardware and/or specially configured software. FIG. 8 is a block diagram of a prioritization computer in accordance with the present invention. The hardware of the prioritization computer is of a type generally known in the art. The prioritization computer 100 includes a central processing unit (“CPU”) 102, a memory 104, e.g., random access memory (“RAM”), read only memory (“ROM”) and/or a storage device such as a hard disk drive, and a telecommunications device 106 for communicating via a communications network, e.g., using TCP/IP technology. The telecommunications device may include a modem and/or a network card connected via a communications port 108. The mail server may optionally include a video display device 110 and/or input devices 112.

The prioritization computer may be a mail client computer for receiving and prioritizing electronic mail, a mail client computer for sending electronic mail, or a mail server computer for prioritizing and routing electronic mail. When the prioritization computer 100 is configured as a mail client computer for receiving and prioritizing electronic mail, it stores CPU executable programs in its memory 104 including a first program executable for storing an auction pool comprising a plurality of electronic mail messages, each of said electronic mail messages comprising a respective priority bid, a second program for receiving an incoming electronic mail message having a priority bid; a third program for determining if said priority bid of said incoming electronic mail message is less than or equal to said respective priority bid of any of said electronic mail messages in said auction pool, and for responsively increasing said priority bid of said incoming electronic mail message to exceed said respective priority bid, a fourth program for adding said incoming electronic mail message to said auction pool, and a fifth program for causing to be displayed, in descending order of priority bids, a list of said electronic mail messages in said auction pool.

When the prioritization computer 100 is configured as a mail client computer for sending electronic mail, it stores CPU executable programs in its memory 104 including a first program for storing an auction pool comprising a plurality of electronic mail messages, each of said electronic mail messages comprising a respective priority bid, a second program for receiving an incoming electronic mail message having a priority bid, a third program for determining if said priority bid of said incoming electronic mail message is less than or equal to said respective priority bid of any of said electronic mail messages in said auction pool, and for responsively increasing said priority bid of said incoming electronic mail message to exceed said respective priority bid, a fourth program for adding said incoming electronic mail message to said auction pool, and a fifth program for causing to be displayed, in descending order of priority bids, a list of said electronic mail messages in said auction pool.

When the prioritization computer 100 is configured as a mail server computer for prioritizing and routing electronic mail, it stores CPU executable programs in its memory 104 including a first program for preparing an electronic mail message for transmission to a recipient, said electronic mail message comprising maximum bid data reflecting a maximum amount receivable by said recipient, and a second program for transmitting said electronic mail message via said electronic mail system.

Software for prioritization of a user's electronic mail messages in accordance with the present invention can also be embodied in a computer program product. The present invention provides a method and apparatus for providing a categorized display of a recipient's electronic mail messages.

The computer of FIG. 8 could also be configured as an exemplary electronic mail categorization computer in accordance with the present invention. The categorization computer 100 may be a mail client computer for receiving and categorizing electronic mail, a mail client computer for sending categorizable electronic mail, or a mail server computer for categorizing and routing electronic mail. When the categorization computer 100 is configured as a mail client computer for receiving and categorizing electronic mail, it stores CPU executable programs in its memory 104 including a first program for receiving an electronic mail message, a second program for associating said electronic mail message with a category, and a third program for causing information identifying the electronic mail message to be displayed in a corresponding section of a plurality of sections of a mail reader display, the corresponding section corresponding to the category.

When the categorization computer 100 is configured as a mail client computer for sending categorizable electronic mail, it stores CPU executable programs in its memory 104 including a first program for preparing an electronic mail message for transmission to a recipient, a second program for including in the electronic mail message category identification data usable to associate the electronic mail message with a corresponding section of a plurality of sections of the recipient's mail reader display, and a third program for transmitting the electronic mail message via the electronic mail system.

When the categorization computer 100 is configured as a mail server computer for categorizing electronic mail, it stores CPU executable programs in its memory 104 including a first program for receiving an electronic mail message, a second program for associating said electronic mail message with a category, and a third program for causing information identifying the electronic mail message to be displayed in a corresponding section of a plurality of sections of a mail reader display, the corresponding section corresponding to the category.

The present invention also provides a computer program product for sending categorizable electronic mail messages. The computer program product has a computer usable medium having computer readable program code embodied in the medium. The computer program product has computer readable code for including in an electronic mail message category identification data usable to associate the electronic mail message with a corresponding section of a plurality of sections of a mail reader display.

Additionally, the present invention provides a computer program product for categorizing a recipient's electronic mail messages. The computer program product has a computer usable medium having computer readable program code embodied in the medium. The computer program product has: computer readable code for receiving an electronic mail message; computer readable code for associating the electronic mail message with a category; and computer readable code for causing information identifying the electronic mail message to be displayed in a corresponding section of a plurality of sections of a mail reader display, the corresponding section corresponding to the category.

It is noted that the present invention may be advantageously combined with a spam routing system such as that disclosed in U.S. application Ser. No. ______ titled Method And Apparatus For Selective Delivery And Forwarding of Electronic Mail (Attorney Docket No. P24618 USA), filed ______, now U.S. Pat. No. ______, issued ______, the disclosure of which is incorporated herein by reference. For example, the categorization system disclosed herein can result in routing in accordance with the method disclosed in this application, e.g., certain messages in certain categories can be routed to alternate e-mail addresses. Additionally, for example, message categories, e.g., “BILLS”, can be further processed, e.g., by causing deposit of a message into such a category to cause triggering of automated bill payment or other software, such as Quicken financial software.

Additionally, the present invention may be advantageously combined with methods and apparatuses for rule-based processing of electronic mail messages as disclosed in U.S. application Ser. No. ______ titled System and Method for Conducting Predefined Transactions via an Electronic Mail Messaging Infrastructure (Attorney Docket No. P24526 USA), filed ______, now U.S. Pat. No. ______, issued ______, U.S. application Ser. No. ______ titled System and Method for Rule-based Processing of Electronic Mail Messages (Attorney Docket No. P24528 USA), filed ______, now U.S. Pat. No. ______, issued ______, and U.S. application Ser. No. ______ titled Reply Based Electronic Mail Transactions (Attorney Docket No. P24763 USA), filed ______, now U.S. Pat. No. ______, issued ______, the disclosures of which are incorporated herein by reference.

For example, when combined with U.S. application Ser. No. ______ titled System and Method for Rule-based Processing of Electronic Mail Messages (Attorney Docket No. P24528 USA), filed ______, now U.S. Pat. No. ______, issued ______, the present invention may be used to dynamically determine a priority bid payable to a recipient for incentivizing a recipient to receive and/or read a message and/or otherwise act, whereby the priority bid amount is determined in a personalized, one-to-one manner based on a review of a client side (or remotely stored) data store of information unique to the intended recipient of the electronic mail message. The messages may then be dynamically prioritized and/or categorized in accordance with the present invention. By way of further example, an automated transaction for determining a least cost supplier of a good or service in reply to a request for proposal can result in replies that can be dynamically prioritized and/or categorized in accordance with the present invention. Additionally, for example, message categories, e.g., “BILLS”, can be further processed, e.g., by causing deposit of a message into such a category to cause triggering of automated bill payment or other software, such as Quicken financial software.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for prioritization of a user's electronic mail messages, the method comprising the steps of:
(a) storing an auction pool comprising a plurality of electronic mail messages, each of said electronic mail messages comprising a respective priority bid;
(b) receiving an incoming electronic mail message having a priority bid;
(c) if said priority bid of said incoming electronic mail message is less than or equal to said respective priority bid of any of said electronic mail messages in said auction pool, increasing said priority bid of said incoming electronic mail message to exceed said respective priority bid;
(d) adding said incoming electronic mail message to said auction pool; and
(e) causing to be displayed, in descending order of priority bids, a list of said electronic mail messages in said auction pool.

2. The method of claim 1, wherein step (d) comprises storing said incoming message.

3. The method of claim 1, further comprising the step of:
(f) identifying a maximum bid for said incoming electronic mail message; wherein step (c) comprises increasing said priority bid of said incoming electronic mail message to an amount less than or equal to said maximum bid.

4. The method of claim 1, further comprising the steps of:
(g) if said respective priority bid of said any of said electronic mail messages is less than or equal to said priority bid of said incoming electronic mail message, increasing said respective priority bid of said any of said electronic mail messages to exceed said priority bid of said incoming electronic mail message;
step (g) being performed before step (d).

5. The method of claim 4, wherein said any of said electronic mail messages is selected from said auction pool because said any of said electronic mail messages has a respective priority bid which is highest among said electronic mail messages of said auction pool.

6. The method of claim 1, further comprising the steps of:
(h) if said respective priority bid of any other electronic mail message in said auction pool is less than or equal to said priority bid of said incoming electronic mail message, increasing said priority bid of said any other electronic mail message to exceed said priority bid of said incoming electronic mail message;
step (h) being performed before step (d).

7. The method of claim 1, further comprising the step of:
(i) receiving compensation in an amount of said priority bid

8. The method of claim 7, wherein step (i) is performed responsive to said user's performance of a certain act.

9. The method of claim 8, wherein said certain act is selected from the group consisting of: opening said message, replying to said message, selecting a link contained in said message to click through to a website, referring another to a website, registering with a website, subscribing to a website, and combinations of two or more thereof.

10. The method of claim 4, further comprising the step of:
(j) receiving compensation in an amount of said priority bid

11. The method of claim 10, wherein step (j) is performed responsive to said user's performance of a certain act.

12. The method of claim 11, wherein said act is selected from the group consisting of: opening said message, replying to said message, selecting a link contained in said message to click through to a website, referring another to a website, registering with a website, subscribing to a website, and combinations of two or more thereof.

13. A method for prioritization of a user's electronic mail messages comprising the steps of:
(a) identifying an existing priority bid of a received electronic mail message;
(b) comparing a priority bid of an incoming electronic mail message to said existing priority bid for said received electronic mail message; and
(c) if said priority bid of said incoming electronic mail message is less than or equal to said existing priority bid of said received electronic mail message, increasing said priority bid for said incoming electronic mail message.

14. The method of claim 13, further comprising the step of:
(d) identifying a maximum bid for said incoming electronic mail message; wherein step (c) comprises increasing said priority bid of said incoming electronic mail message to an amount less than or equal to said maximum bid.

15. The method of claim 13, further comprising the step of:
(e) causing to be displayed to the user, in descending order of priority bids, a list of electronic mail messages.

16. The method of claim 13, wherein said list comprises a display of priority bid value for each respective electronic mail message.

17. The method of claim 13, wherein said list further comprises a display of header information for each respective electronic mail message.

18. The method of claim 16, wherein step (e) comprises displaying said list in an inbox via said user's communications device.

19. The method of claim 13, further comprising the steps of:
(f) receiving said received electronic mail message and said incoming electronic mail message in an incoming message queue of a mail server computer; and
(g) storing said received electronic mail message and said incoming electronic mail message in a memory of said mail server computer; wherein steps (a)-(c) are performed at said mail server computer.

20. The method of claim 13, further comprising the steps of:
(f) receiving said received electronic mail message and said incoming electronic mail message at a user's mail client computer; and
(g) storing said received electronic mail message and said incoming electronic mail message in a memory of said mail client computer; wherein steps (a)-(c) are performed at said mail client computer.

21. The method of claim 13, further comprising the steps of:
(h) identifying a maximum bid for said received electronic mail message;
(i) comparing said existing priority bid of said received electronic mail message to said priority bid for said incoming electronic mail message; and
(j) if said existing priority bid of said received electronic mail message is less than or equal to said priority bid of said incoming electronic mail message, increasing said existing priority bid of said received electronic mail message to an amount less than or equal to said maximum bid for said received electronic mail message.

22. A method for prioritization of a user's electronic mail messages using a computer having a memory, the method comprising the steps of:
(a) storing in said memory an auction pool comprising a plurality of received electronic mail messages, each of said electronic mail messages comprising an associated priority bid;
(b) receiving an incoming electronic mail message having a priority bid;
(c) comparing said priority bid of said incoming electronic mail message to said associated priority bids of said received electronic mail messages; and
(d) if said priority bid of said incoming electronic mail message is less than or equal to a respective associated priority bid of any electronic mail message in said auction pool, increasing said priority bid of said incoming electronic mail message.

23. The method of claim 22, further comprising the steps of:
(e) sorting in descending order of priority bids said electronic mail messages in said auction pool; and
(f) displaying a list of said sorted electronic mail messages.

24. The method of claim 23, further comprising the steps of:
(g) identifying an underbid electronic mail message in said auction pool, said underbid electronic mail message being selected from said electronic mail messages in said auction pool for having an associated priority bid less than or equal to said priority bid of said incoming electronic mail message;
(h) identifying a maximum bid for said underbid electronic mail message;
(i) if said maximum bid for said underbid electronic mail message is greater than said priority bid of said underbid electronic mail message, increasing said priority bid of said underbid electronic mail message.

25. The method of claim 24, further comprising the step of:
(j) repeating steps (c) and (d) for said incoming electronic mail message.

26. The method of claim 25, further comprising the step of:
(k) repeating step (i) for said underbid electronic mail message.

27. The method of claim 25, further comprising the step of:
(l) repeating steps (g)-(i) with respect to a different underbid electronic mail message.

28. A method for sending dynamically prioritizable electronic mail in an electronic mail system comprising:
(a) preparing an electronic mail message for transmission to a recipient, said electronic mail message comprising maximum bid data reflecting a maximum amount receivable by said recipient;
(b) transmitting said electronic mail message via said electronic mail system.

29. The method of claim 28, said electronic mail message further comprising minimum bid data, reflecting a minimum amount receivable by said recipient.

30. The method of claim 29, wherein said maximum bid data and said minimum bid data reflect maximum and minimum, respectively, amounts payable to said recipient by a sender of said electronic mail message.

31. The method of claim 29, wherein said amounts are payable to said recipient in currency.

32. A method for prioritizing electronic mail messages in a user's electronic inbox, the method comprising the steps of:
(a) receiving a plurality of electronic mail messages, each of said messages comprising a respective priority bid, said plurality of message comprising an auction pool;
(b) receiving an incoming electronic mail message having a priority bid;
(c) if said priority bid of said incoming message is less than or equal to said respective priority bid of any message in said auction pool, increasing said priority bid of said incoming message to exceed said respective priority bid;
(d) adding said incoming message to said auction pool; and
(e) displaying in descending order of priority bids a list of said messages in said auction pool.

33. The method of claim 32, further comprising the steps of:
(f) if said respective priority bid of said any message is less than or equal to said priority bid of said incoming message, increasing said priority bid of said any message to exceed said priority bid of said incoming message;
step (f) being performed before step (d).

34. The method of claim 33, wherein said any message comprises a certain electronic mail message in said auction pool having a highest priority bid.

35. The method of claim 32, further comprising the steps of:
(g) if said respective priority bid of any other message is less than or equal to said priority bid of said incoming message, increasing said priority bid of said any other message to exceed said priority bid of said incoming message;
step (f) being performed before step (d).

36. A method for providing a categorized display of a recipient's electronic mail messages, the method comprising the steps of:
(a) receiving an electronic mail message;
(b) associating said electronic mail message with a category;
(c) causing information identifying said electronic mail message to be displayed in a corresponding section of a plurality of sections of a mail reader display, said corresponding section corresponding to said category.

37. The method of claim 36, wherein step (b) comprises the steps of:
(d) identifying a message identifier associated with said message.

38. The method of claim 36, wherein step (d) comprises the step of:
(e) reading said message identifier from a database of message identifiers stored in a memory.

39. The method of claim 37, wherein step (d) comprises the step of:
(f) reading said message identifier from header information of said message.

40. The method of claim 39, wherein step (f) comprises the step of:
(g) reading said message identifier from an identifier field of header information of said message.

41. The method of claim 37, further comprising the steps of:
(h) identifying a corresponding section of a mail reader display.

42. The method of claim 41, wherein step (h) comprises the step of:
(i) referencing a database of message identifiers and corresponding sections.

43. The method of claim 41, wherein step (h) comprises the step of:
(j) comparing said message identifier to a plurality of category identifiers;
(k) identifying a matching category identifier; and
(l) associating said message with a corresponding category associated with said matching category identifier.

44. The method of claim 43, further comprising the step of:
(m) associating said message with a default category if no matching category identifier is identified in step (k).

45. The method of claim 36, wherein said mail reader display comprises an inbox window displayed by a mail reader software program running on a computer, said mail reader display being displayed on a video monitor.

46. The method of claim 36, wherein said section comprises a subwindow of said inbox window.

47. The method of claim 36, wherein said section comprises a column of said inbox window.

48. The method of claim 36, wherein said section corresponds exclusively to said category.

49. The method of claim 36, wherein step (a) comprises receiving said electronic mail message in an incoming message queue of a mail server computer and wherein step (b) is performed at said mail server computer.

50. The method of claim 36, wherein step (a) comprises receiving said electronic mail message in an incoming message queue of a mail server computer and wherein step (b) is performed at a mail client computer.

51. The method of claim 36, wherein step (a) comprises receiving said electronic mail message at a mail client computer and wherein step (b) is performed at said mail client computer.

52. The method of claim 36, wherein step (a) comprises receiving said electronic mail message at a mail client computer and wherein step (b) is performed at a mail server computer.

53. The method of claim 1, further comprising the steps of:
(f) receiving an electronic mail message;
(g) associating said electronic mail message with a category; and
(h) causing information identifying said electronic mail message to be displayed in a corresponding section of a plurality of sections of a mail reader display, said corresponding section corresponding to said category.

54. A method for providing a categorized display of a recipient's electronic mail messages, the method comprising the steps of:
(a) receiving a first electronic mail message comprising a first identifier associated with a first category;
(b) receiving a second electronic mail message comprising a second identifier associated with a second category;
(c) causing information relating to said first electronic mail message to be displayed in a first section of a mail reader display; and
(d) causing information relating to said second electronic mail message to be displayed in a second section of said mail reader display.

55. The method of claim 54, wherein said first section comprises a first column and said second section comprises a second column, at least portions of said first column and said second column being concurrently displayed on a video monitor.

56. A method for sending categorizable electronic mail messages in an electronic mail system, said method comprising:
(a) preparing an electronic mail message for transmission to a recipient;
(b) including in said electronic mail message category identification data usable to associate said electronic mail message with a corresponding section of a plurality of sections of said recipient's mail reader display; and
(c) transmitting said electronic mail message via said electronic mail system.

57. A computer program product for sending categorizable electronic mail messages comprising:
a computer usable medium having computer readable program code embodied in said medium, said computer program product comprising:
computer readable code for including in an electronic mail message category identification data usable to associate said electronic mail message with a corresponding section of a plurality of sections of a mail reader display.

58. A computer program product for categorizing a recipient's electronic mail messages, said computer program product comprising:
a computer usable medium having computer readable program code embodied in said medium, said computer program product comprising:
(a) computer readable code for receiving an electronic mail message;
(b) computer readable code for associating said electronic mail message with a category;
(c) computer readable code for causing information identifying said electronic mail message to be displayed in a corresponding section of a plurality of sections of a mail reader display, said corresponding section corresponding to said category.

59. A mail client computer for receiving and categorizing electronic mail, the mail client computer comprising:
a central processing unit;
a memory operatively connected to said central processing unit;
a telecommunications device operatively connected to said central processing unit and capable of communicating via a communications network;
a first program stored in said memory and executable by said central processing unit for receiving an electronic mail message;
a second program stored in said memory and executable by said central processing unit for associating said electronic mail message with a category; and
a third program stored in said memory and executable by said central processing unit for causing information identifying said electronic mail message to be displayed in a corresponding section of a plurality of sections of a mail reader display, said corresponding section corresponding to said category.

60. A mail server computer for categorizing electronic mail, the mail server computer comprising:
a central processing unit;
a memory operatively connected to said central processing unit;
a telecommunications device operatively connected to said central processing unit and capable of communicating via a communications network;
a first program stored in said memory and executable by said central processing unit for receiving an electronic mail message;
a second program stored in said memory and executable by said central processing unit for associating said electronic mail message with a category; and
a third program stored in said memory and executable by said central processing unit for causing information identifying said electronic mail message to be displayed in a corresponding section of a plurality of sections of a mail reader display, said corresponding section corresponding to said category.

61. A mail client computer for sending categorizable electronic mail, the mail client computer comprising:
a central processing unit;
a memory operatively connected to said central processing unit;
a telecommunications device operatively connected to said central processing unit and capable of communicating via a communications network;
a first program stored in said memory and executable by said central processing unit for preparing an electronic mail message for transmission to a recipient;
a second program stored in said memory and executable by said central processing unit for including in said electronic mail message category identification data usable to associate said electronic mail message with a corresponding section of a plurality of sections of said recipient's mail reader display; and
a third program stored in said memory and executable by said central processing unit for transmitting said electronic mail message via said electronic mail system.

62. A computer program product for prioritization of a user's electronic mail messages comprising:
a computer usable medium having computer readable program code embodied in said medium, said computer program product comprising:
(a) computer readable code for storing an auction pool comprising a plurality of electronic mail messages, each of said electronic mail messages comprising a respective priority bid;
(b) computer readable code for receiving an incoming electronic mail message having a priority bid;
(c) computer readable code for determining if said priority bid of said incoming electronic mail message is less than or equal to said respective priority bid of any of said electronic mail messages in said auction pool, and for responsively increasing said priority bid of said incoming electronic mail message to exceed said respective priority bid;
(d) computer readable code for adding said incoming electronic mail message to said auction pool; and
(e) computer readable code for causing to be displayed, in descending order of priority bids, a list of said electronic mail messages in said auction pool.

63. A mail client computer for receiving and prioritizing electronic mail, the mail client computer comprising:
a central processing unit;
a memory operatively connected to said central processing unit;
a telecommunications device operatively connected to said central processing unit and capable of communicating via a communications network;
a first program stored in said memory and executable by said central processing unit for storing an auction pool comprising a plurality of electronic mail messages, each of said electronic mail messages comprising a respective priority bid;
a second program stored in said memory and executable by said central processing unit for receiving an incoming electronic mail message having a priority bid;
a third program stored in said memory and executable by said central processing unit for determining if said priority bid of said incoming electronic mail message is less than or equal to said respective priority bid of any of said electronic mail messages in said auction pool, and for responsively increasing said priority bid of said incoming electronic mail message to exceed said respective priority bid;
a fourth program stored in said memory and executable by said central processing unit for adding said incoming electronic mail message to said auction pool;
a fifth program stored in said memory and executable by said central processing unit for causing to be displayed, in descending order of priority bids, a list of said electronic mail messages in said auction pool.

64. A mail server computer for prioritizing electronic mail, the mail client computer comprising:
a central processing unit;
a memory operatively connected to said central processing unit;
a telecommunications device operatively connected to said central processing unit and capable of communicating via a communications network;
a first program stored in said memory and executable by said central processing unit for storing an auction pool comprising a plurality of electronic mail messages, each of said electronic mail messages comprising a respective priority bid;
a second program stored in said memory and executable by said central processing unit for receiving an incoming electronic mail message having a priority bid;
a third program stored in said memory and executable by said central processing unit for determining if said priority bid of said incoming electronic mail message is less than or equal to said respective priority bid of any of said electronic mail messages in said auction pool, and for responsively increasing said priority bid of said incoming electronic mail message to exceed said respective priority bid;
a fourth program stored in said memory and executable by said central processing unit for adding said incoming electronic mail message to said auction pool;
a fifth program stored in said memory and executable by said central processing unit for causing to be displayed, in descending order of priority bids, a list of said electronic mail messages in said auction pool.

65. A mail client computer for sending electronic mail, the mail client computer comprising:
a central processing unit;
a memory operatively connected to said central processing unit;
a telecommunications device operatively connected to said central processing unit and capable of communicating via a communications network;
a first program stored in said memory and executable by said central processing unit for preparing an electronic mail message for transmission to a recipient, said electronic mail message comprising maximum bid data reflecting a maximum amount receivable by said recipient; and
a second program stored in said memory and executable by said central processing unit for transmitting said electronic mail message via said electronic mail system.
